(19) United States
(12) Patent Application Publication
(10) Pub. No.: US 2002/0154081 A1
(43) Pub. Date: Oct. 24, 2002

(54) Liquid crystal display apparatus

(76) Inventors: Minoru Niimura, Tokyo-to (JP); Takashi Kimura, Shiojiri-shi (JP); Katsumi Tsukada, Ina-shi (JP); Hirotsuna Miura, Suwa-gun (JP)

Correspondence Address: HARNESS, DICKEY & PIERCE, P.L.C., P.O. BOX 828, BLOOMFIELD HILLS, MI, 48303, US

(21) Appl. No.: 10/124,744

(22) Filed: Apr. 17, 2002

(30) Foreign Application Priority Data
Apr. 18, 2001 (JP) 2001-120223

(51) Int. Cl. G09G 3/36

(52) U.S. Cl. 345/87

(57) ABSTRACT

A semiconductor memory is used to retain execution code and data for a CPU and display data for a liquid crystal controller, also used as a temporary work memory to be used when moving picture data such as MPEG is subject to a decoding process, and also used to retain decoded moving picture data.

### BACKGROUND OF THE INVENTION

1. Technical Filed of the Invention

The present invention relates to a liquid crystal display apparatus equipped with a device that processes moving pictures and still pictures, more particularly to a liquid crystal display apparatus that effectively uses a memory for display.

2. Conventional Technology

A conventional liquid crystal display apparatus needs three types of memories such as a main memory 2 for storing execution code and data for a CPU 1, a work memory 4 for a moving picture processing apparatus 3, and a display memory 8 of a liquid crystal controller 7 for storing display data, as indicated in FIG. 1. In FIG. 1, arrows with curved lines indicate flows of data. More specifically, when moving picture data such as MEPG 4 are reproduced, first, moving picture data taken from an auxiliary storage apparatus or the like by the CPU 1 is sent to the moving picture processing apparatus 3, and the moving picture processing apparatus 3 decodes the data using the work memory 4 and writes the same in the main memory 2. The CPU 1 transfers only part of the data required for displaying to the liquid crystal controller 7, and such data is stored in the display memory 8. The liquid crystal controller 7 reads out the display data from the display memory 8 in synchronism with the refresh timing of the line driver 9, and transfers the same to the line driver 9.

Another system may use a UMA structure that shares the main memory 2 and the display memory 8. In this case, the liquid crystal controller 7 reads data from the main memory 2 in synchronism with the refresh timing, instead of reading from the display memory 8.

When a signal is inputted from the picture photographing apparatus 11, the data is processed by the moving picture processing apparatus 3, and then stored in the main memory 2.

In the system using a UMA memory, as described above, data taking of display data periodically occurs in synchronism with the refresh timing on a bus that connects the CPU and the main memory. This causes a problem in that the bandwidth used by the CPU for memory accesses is reduced.

Also, the work memory, which is required when moving pictures are reproduced, becomes wasteful, as it is not used unless moving pictures are reproduced.

Furthermore, since the signal from the picture photographing apparatus is outputted without regard to the color characteristic of the liquid crystal panel, the color reproducibility of a picture displayed with respect to a picture photographed is very poor.

If data from the picture photographing apparatus is once inputted in the main memory, the data is subject to a required process by the software, and the data is sent to the liquid crystal controller, a problem occurs in that the operation speed of the CPU and the bandwidth of the bus need to be made greater to make it possible to display moving pictures (i.e., to display pictures at 15 frames per second or greater).

For example, when a picture of QCIF size (176×144 dots, each dot having 24-bit colors) is displayed at 15 frames per second, the data transfer rate is given as follows.

176×144×(24/8)×15=1,140,480 Bytes/sec (about 1.1 MB/s)

To process this data, the CPU needs to perform data reading and writing with the main memory two to three times, and a bus width of 2.2 MB/sec—3.3 MB/sec is used by the CPU for the data processing.

Also, when the UMA structure is used for the memory for display data, accesses to the main memory always occur at a predetermined rate for displaying. For example, when the refresh rate of the liquid crystal panel is 60 Hz, the associated data transfer rate is given as follows.

176×144×(24/8)×60=4,561,920 Bytes/sec (about 4.5 MB/s)

Accordingly, when the CPU and the liquid crystal controller transfer only data for displaying, a bus bandwidth of about 4.5 MB/s is occupied.

In other words, the structure in which the main memory for the CPU and the display memory are separated from one another has a drawback of poor memory use efficiency, and the UMA structure occupies a substantial bus bandwidth only for the transfer of display data, which causes to slow down the overall processing speed of the system.

Also, if data from the picture photographing apparatus is once stored in the main memory as shown in FIG. 1, and the data is sent to the liquid crystal controller 7 after the data is processed by the CPU 1, a certain bus bandwidth is occupied to a degree, which becomes another cause to slow down the overall processing speed of the system.

Furthermore, when the display is refreshed in synchronism with the display timing of the liquid crystal panel, data transfer always takes place even when there is no change in the display data. This causes another problem of an increase in the overall power consumption of the system.

### SUMMARY OF THE INVENTION

To solve the problems described above, a liquid crystal display apparatus in accordance with the present invention is characterized in comprising: a liquid crystal display panel equipped with a common driving driver and a line driving driver; a device that transfers display data to the liquid crystal display panel; a semiconductor memory that retains data; and a device that decodes MPEG data, wherein the semiconductor memory retains execution code and data for a CPU and display data for the liquid crystal controller, is also used as a temporary work storage used when a process of decoding moving picture data such as MEPG is conducted, and also is used to retain decoded moving picture data.

Also, a liquid crystal display apparatus in accordance with the present invention is characterized in comprising: a liquid crystal display panel equipped with a common driving driver and a line driving driver; a device that transfers display data to the liquid crystal display panel; a semiconductor memory that retains data; a device that decodes MPEG data; and an input device for a picture photographing device, wherein an output signal from the picture photographing device is composed of a luminance signal (Y), and a color difference signal (Cr, Cb) (i.e., YUV signal; and a device that takes in the YUV signal, converts the same to red (R), green (G) and blue (B) signals, which is to be written in the semiconductor memory.

Also, a liquid crystal display apparatus in accordance with the present invention is characterized in that the line driving driver has a display data storage memory mounted.

Also a liquid crystal display apparatus in accordance with the present invention is characterized in that the RGB signal is directly outputted to the liquid crystal panel instead of being stored in the semiconductor memory.

Also a liquid crystal display apparatus in accordance with the present invention is characterized in further comprising a device that converts the YUV signal that is an output signal of the MPEG decoder to an RGB signal, and a DMA controller that writes the RGB signal in a picture display memory region within the UMA memory, and transmits image data to the liquid crystal panel in synchronism with completion of writing data for one frame of MPEG picture.

Also a liquid crystal display apparatus in accordance with the present invention is characterized in that an output signal of the liquid crystal controller is passed through an apparatus equipped with a color conversion table to be converted into a signal having a color characteristic different from that of the output signal.

Also a liquid crystal display apparatus in accordance with the present invention is characterized in further comprising a device that thins out the RGB signal according to a dot structure of the liquid crystal panel.

Also a liquid crystal display apparatus in accordance with the present invention is characterized in further comprising a device that thins out the RGB signal according to a dot structure of the liquid crystal panel and reduces the number of colors that can be processed by a driver of the liquid crystal panel.

### BRIEF DESCRIPTION OF THE DRAWINGS

FIG. 1 is a diagram for describing a conventional technology.

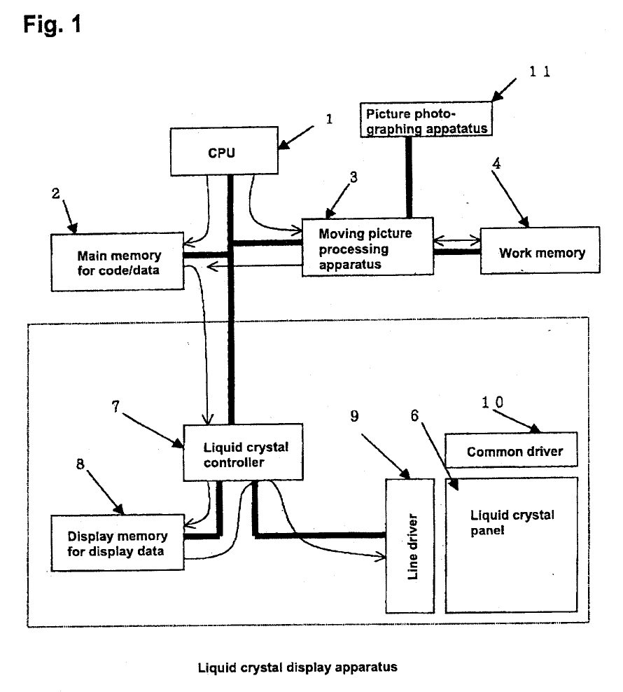

FIG. 2 is a diagram for describing a liquid crystal display apparatus.

FIG. 3 is a diagram for describing a liquid crystal display apparatus.

FIG. 4 is a diagram for describing a liquid crystal display apparatus.

FIG. 5 is a diagram for describing a liquid crystal display apparatus.

FIG. 6 is a diagram for describing a liquid crystal display apparatus.

FIG. 7 is a diagram for describing a liquid crystal display apparatus.

FIG. 8 is a diagram for describing a liquid crystal display apparatus.

FIG. 9 is a diagram for describing a liquid crystal display apparatus.

### DETAILED DESCRIPTION OF THE PREFERRED EMBODIMENTS OF THE PRESENT INVENTION

Liquid crystal display apparatuses in accordance with the present invention will be described in detail with reference to the accompanying drawings.

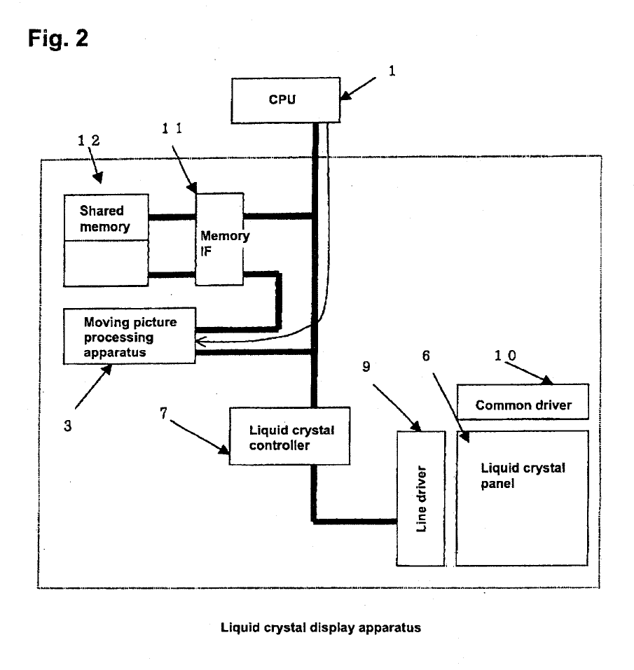

FIG. 2 shows a structure of a liquid crystal display apparatus. A shared memory 12 in FIG. 2 functions as a storage for storing execution code and data for the CPU 1, a work memory for a moving picture processing apparatus 3, and a memory for storing display data for a liquid crystal controller 7. The shared memory 12, when it does not handle moving pictures, functions as a common UMA memory for the CPU and the liquid crystal controller. In other words, a memory IF 11 arbitrates accesses from the CPU 1 and accesses from the liquid crystal controller 7, such that the entire memory region of the shared memory 12 is accessible.

When a moving picture needs to be processed, the CPU 1 writes data in the moving picture processing apparatus 3 as indicated by an arrow, the moving picture processing apparatus 3 stores a processing result as a frame picture in the shared memory 12. In this instance, the memory IF 11 controls such that the data can be accessed to the shared memory 12 through a different route so as not to restrict accesses from the CPU 1 and the liquid crystal controller 7. In other words, the shared memory 12 functions as a dual port memory, such that it becomes accessible depending on the requirements of the moving picture processing apparatus 3. In the mean time, the liquid crystal controller 7 reads out required display data from the shared memory 12 according to the refresh timing of a line driver 9.

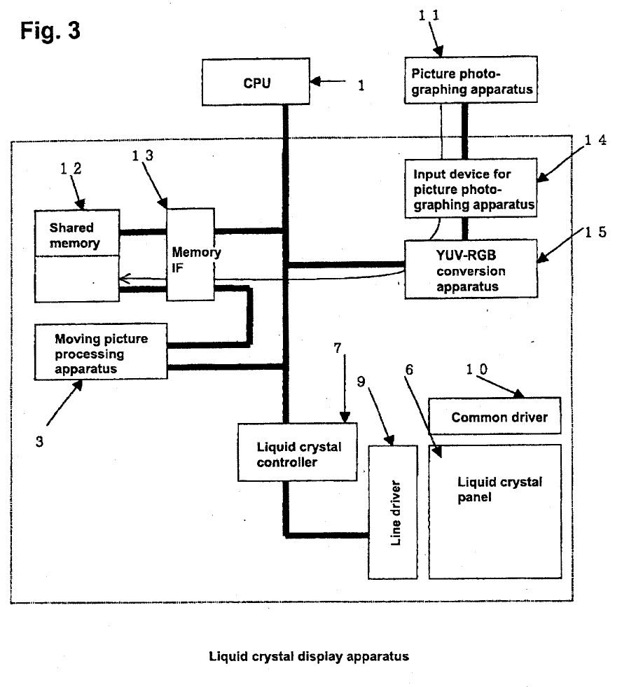

FIG. 3 shows a structure of a liquid crystal display apparatus. A picture photographing apparatus 11 is formed from a CMOS image sensor or a CCD image sensor, and outputs color signals (YUV signals such as luminance signals and color difference signals). An input device 14 is a port such as a serial port, a parallel port or the like for inputting the color signals in a digital format. A conversion apparatus 15 is an apparatus that has functions to convert YUV signals inputted from the picture photographing apparatus 11 to RGB signals, and writes the same in the shared memory 12.

An RGB signal, which is written in the shared memory 12, is converted by the function of the CPU 1 into a format that matches the format of the liquid crystal panel 6, and written in a region on the shared memory secured for displaying by the liquid crystal controller 7. The liquid crystal controller 7 reads data from the display memory region in synchronism with the refreshing timing of the line driver 9, and feeds the same to the line driver 9, whereby the data is displayed on the liquid crystal panel 9.

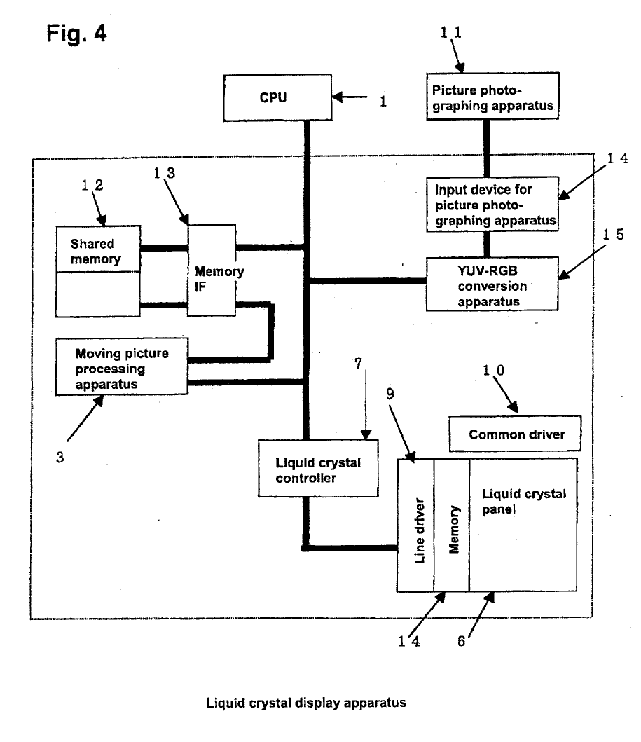

FIG. 4 shows a structure of a liquid crystal display apparatus. It is similar to the invention in its basic structure, but different in that a memory 14 is mounted on a line driver 9. Its operation is also similar to the invention, but a liquid crystal controller 7 operates in a substantially different manner. More specifically, since the liquid crystal controller 7 refreshes the display on the liquid crystal panel at a timing directed by the CPU 1, it is basically asynchronous with the refresh timing of the line driver 9. The line driver 9 refreshes the display on the liquid crystal panel 6 at a required timing by using data stored in the built-in memory 14.

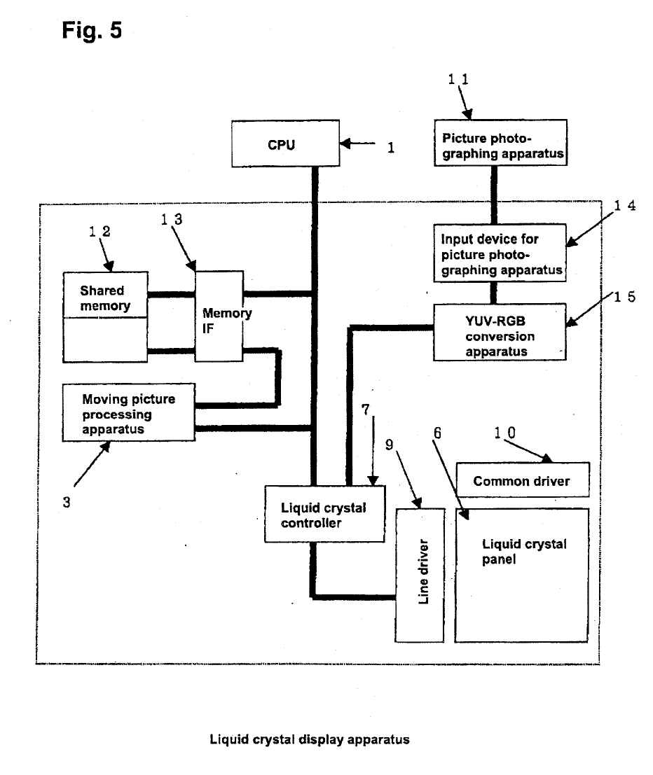

FIG. 5 shows a structure of a liquid crystal display apparatus. It is similar to the invention in its basic structure, but different in that a conversion apparatus 15 transfers RGB signals to a liquid crystal controller 7. The conversion apparatus 15 transfers RGB signals to the liquid crystal controller 7 in accordance with the number of dots of the liquid crystal panel 6 by an instruction of the liquid crystal controller 7, and in synchronism with the refresh timing of the line driver 9, such that picture data from a picture photographing apparatus can be directly displayed on the liquid crystal panel.

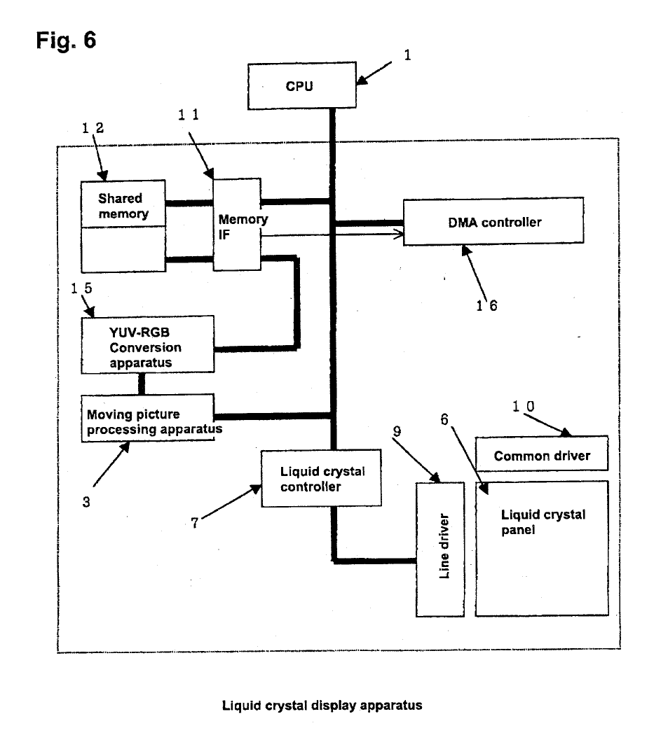

FIG. 6 shows a structure of a liquid crystal display apparatus. A moving picture processing apparatus 3 provides an output in a YUV format, which is converted by a conversion apparatus into an RGB signal format, and written through a memory IF 11 in a shared memory 12. The memory IF 11 monitors write addresses of the shared memory and, upon detecting the completion of writing of moving picture data for one frame, transfers a signal to a DMA controller 16. The DMA controller 16, upon receiving the signal, reads data of moving picture for one frame from the shared memory 12, and transfers the same to the liquid crystal controller 7. This series of operations is repeated 15 times per second, such that the display of moving picture is enabled.

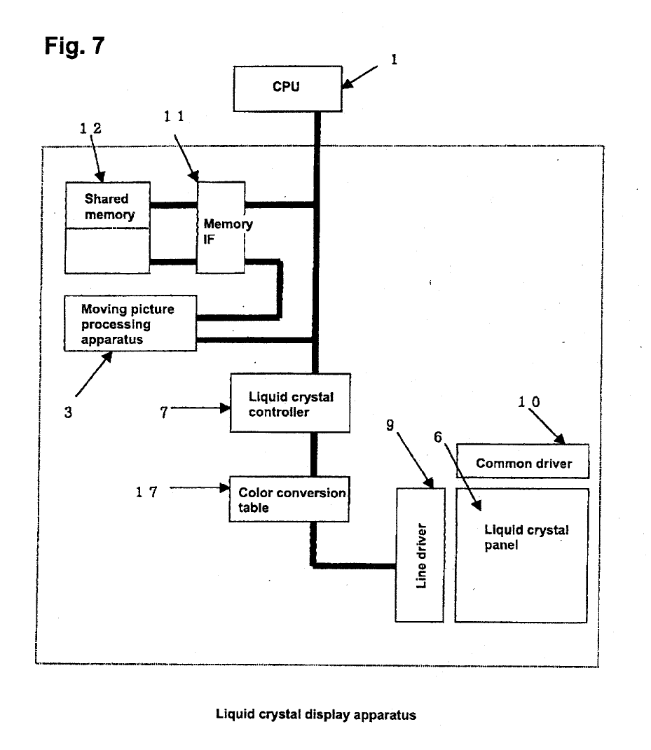

FIG. 7 shows a structure of a liquid crystal display apparatus. It is similar to the invention in its basic structure, but different in that a color conversion table 17 is provided between a liquid crystal controller 7 and a line driver 9. In the liquid crystal display apparatus, picture data processed by the moving picture processing apparatus 3 is displayed as it is. However, even when data that is photographed and transferred is displayed, the original colors may not necessarily be perfectly reproduced. This is because the color space of the liquid crystal panel is very narrow compared to a display apparatus such as a CRT, and the operation of liquid crystal molecules with respect to the output voltage of the liquid crystal driver is non-linear such that its output becomes non-linear even when the input has a linear characteristic.

In view of the above, the present invention devises such that the color characteristic of a picture originally photographed and that of a picture displayed on the liquid crystal panel become as close as possible by performing a conversion in a manner to correct the non-linear characteristic of the liquid crystal panel beforehand. In other words, a combination of colors is inputted in the color conversion table 17, and a combination of corrected colors is outputted, such that the reproduction of a picture with colors close to the original colors is made possible. The color conversion table can be readily realized by an apparatus such as a ROM. A color combination inputted is given addresses, and the color combination outputted may be taken from the data lines.

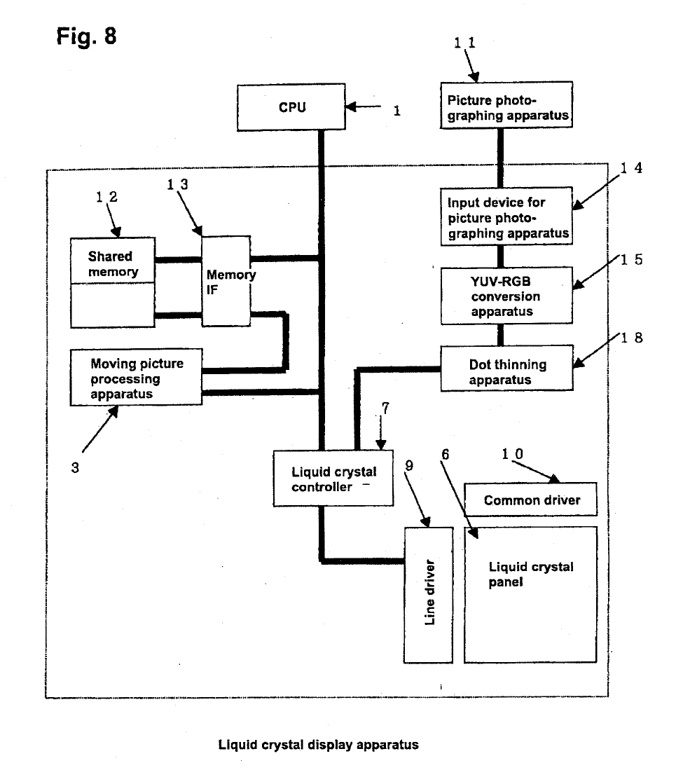

FIG. 8 shows a structure of a liquid crystal display apparatus. It is similar to the invention in its basic structure, but different in that a dot thinning apparatus 18 is inserted in a signal processing route from a picture photographing apparatus 11. The picture photographing apparatus 11 of the liquid crystal display apparatus outputs data that matches the number of dots of the liquid crystal panel by an instruction of the liquid crystal controller 7. However, not all picture photographing apparatuses are necessarily equipped with such a function. In view of this, the present invention is provided to cope with a situation in which a picture photographing apparatus is not equipped with such a function.

When an output format of the picture photographing apparatus 11 is CIF (352 dots×288 dots), and the number of dots that can be displayed by the liquid crystal panel is QCIF (176 dots×144 dots), the dots need to be thinned out by the dot thinning apparatus 18 to one fourth. When thinning out the dots, one out of each four dots may simply be extracted. However, in this case, the picture information is simply reduced to one fourth, and therefore the picture quality lowers to one fourth. Instead, when an average of each four dots is outputted as one dot, the thinning can be performed without lowering the picture quality so much.

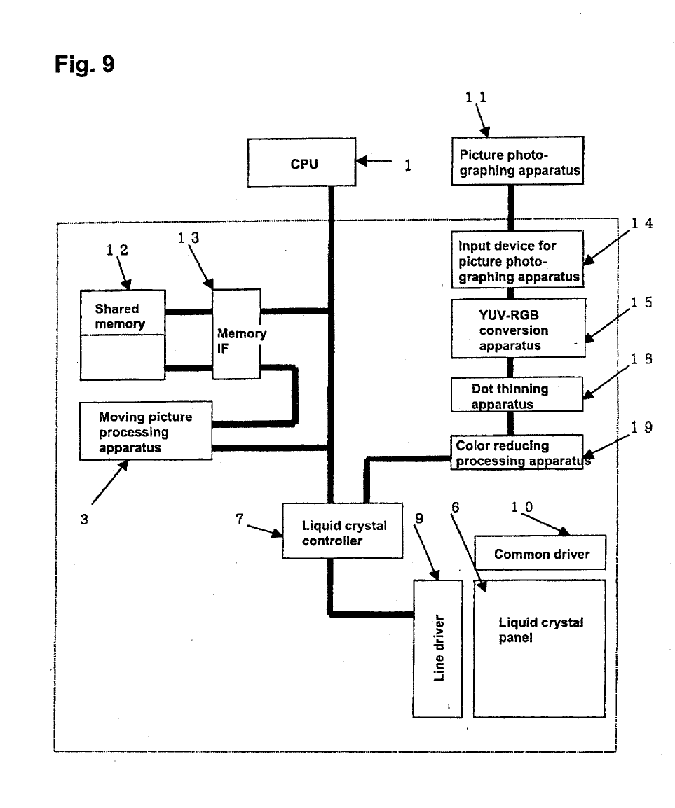

FIG. 9 shows a structure of a liquid crystal display apparatus. It is similar to the invention in its basic structure, but different in that a color reducing processing apparatus is further added after the dot thinning apparatus 18. Color information that is outputted from the picture photographing apparatus 11 normally has 24 bits. However, a liquid crystal panel may not necessarily be able to output color information in 24 bits. In this case, a color reducing process may need to be performed on the way.

In this manner, in the liquid crystal display apparatus in accordance with the present invention, one memory can be shared by a CPU, a liquid crystal controller and a moving picture processing apparatus. Therefore, the reduction in the bandwidth for memory accesses by the CPU can be suppressed, the memory requirement for display can be reduced, and the overall cost can be lowered.

The entire disclosure of Japanese Patent Application No. 2001-120223 filed Apr. 18, 2001 is incorporated by reference.

1. A liquid crystal display apparatus comprising:
a liquid crystal display panel equipped with a common driving driver and a line driving driver;
a device that transfers display data to the liquid crystal display panel;
a semiconductor memory that retains data; and
a device that decodes MPEG data,
a unified memory architecture that the semiconductor memory retains execution code and data for a central processing unit and display data for the a device that transfers display data to the liquid crystal display panel, is also used as a temporary work storage used when a process of decoding moving picture data such as MEPG is conducted, and also is used to retain decoded moving picture data.

2. A liquid crystal display apparatus comprising:
a liquid crystal display panel equipped with a common driving driver and a line driving driver;
a device that transfers display data to the liquid crystal display panel;
a semiconductor memory that retains data;
a device that decodes MPEG data;
an input device for a picture photographing device,
wherein an output YUV signal from the picture photographing device is composed of a luminance signal (Y), and a color difference signal (Cr, Cb); and
a device that takes in the output YUV signal, converts the same to a RGB signal including red (R), green (G) and blue (B), which is to be written in the semiconductor memory.

3. A liquid crystal display apparatus according to claim 1, wherein the line driving driver has a display data storage memory mounted.

4. A liquid crystal display apparatus according to claim 2, wherein the RGB signal is directly outputted to the liquid crystal panel instead of being stored in the semiconductor memory.

5. A liquid crystal display apparatus according to claim 1, further comprising a YUV-RGB conversion apparatus that converts the output YUV signal that is an output signal of the device that decodes MPEG data to an RGB signal, and a DMA controller that writes the RGB signal in a picture display memory region within the unified memory architecture memory, and transmits image data to the liquid crystal panel in synchronism with completion of writing data for one frame of MPEG picture.

6. A liquid crystal display apparatus according to claim 1, wherein an output signal of the device that transfers display data to the liquid crystal display panel is passed through an LUT apparatus equipped with a color conversion table to be converted into a signal having a color characteristic different from that of the output signal.

7. A liquid crystal display apparatus according to claim 4, further comprising a device that thins out the RGB signal according to a dot structure of the liquid crystal panel.

8. A liquid crystal display apparatus according to claim 4, further comprising a device that thins out the RGB signal according to a dot structure of the liquid crystal panel and reduces the number of colors that can be processed by a driver of the liquid crystal panel.
